(19) United States
(12) Patent Application Publication
(10) Pub. No.: US 2022/0288957 A1
(43) Pub. Date: Sep. 15, 2022

(54) PRINTING APPARATUS

(71) Applicant: SEIKO EPSON CORPORATION, Tokyo (JP)

(72) Inventors: Takuro ISHIKURA, Ueda-shi (JP); Daisuke HIRUMA, Matsumoto-shi (JP)

(21) Appl. No.: 17/654,193

(22) Filed: Mar. 9, 2022

(30) Foreign Application Priority Data
Mar. 12, 2021 (JP) 2021-040001

(51) Int. Cl. B41J 25/00; B41J 2/175

(52) U.S. Cl. CPC B41J 25/001; B41J 2/17523; B41J 29/13

(57) ABSTRACT

A printing apparatus includes a head configured to discharge ink, a carriage mounted with the head and configured to reciprocate in a scanning direction, an tube coupling the head and a tank, a holding unit configured to hold the ink tube, a support unit including a support face that supports the holding unit, and a sensor configured to detect the ink, wherein the holding unit moves in the scanning direction with the ink tube curving in a convex shape toward one direction in the scanning direction, the holding unit includes a flat portion that comes into contact with and separates from the support face of the support unit according to the reciprocating movement of the carriage, and the sensor is arranged on one end side of the support unit in the direction in which the ink tube curves in the convex shape.

The present application is based on, and claims priority from JP Application Serial Number 2021-040001, filed Mar. 12, 2021, the disclosure of which is hereby incorporated by reference herein in its entirety.

### BACKGROUND

### 1. Technical Field

The disclosure relates to a printing apparatus.

### 2. Related Art

As disclosed in JP-A-2020-121493, a printing apparatus including a carriage configured to reciprocate in a scanning direction, a head mounted on the carriage and configured to discharge ink, an ink tank in which ink is stored, and a supply tube coupling the head and the ink tank, is known.

In the printing apparatus as described above, since the supply tube also moves while deforming in a curved shape as the carriage reciprocates, ink may leak from a joint portion of the supply tube or the like. Therefore, there is a need for installing a sensor that detects ink leakage. However, there is a problem that the configuration becomes complicated when the detection sensor is installed everywhere in the printing apparatus.

### SUMMARY

A printing apparatus includes a head configured to discharge ink, a carriage mounted with the head and configured to reciprocate in a scanning direction, an ink tank configured to store the ink, an ink tube coupling the head and the ink tank, a holding unit configured to hold the ink tube and move in the scanning direction with the carriage, a support unit extending in the scanning direction and including a support face that supports the holding unit from below, and a detection sensor configured to detect presence or absence of the ink, wherein the holding unit moves in the scanning direction with the ink tube curving in a convex shape toward one direction in the scanning direction, the holding unit includes a flat portion that comes into contact with and separates from the support face of the support unit according to the reciprocating movement of the carriage, and the detection sensor is arranged on one end side of the support unit in the direction in which the ink tube curves in the convex shape.

### BRIEF DESCRIPTION OF THE DRAWINGS

FIG. 1 is an external perspective view illustrating a configuration of a printing apparatus.

FIG. 2 is a side cross-sectional view illustrating a configuration of the printing apparatus.

FIG. 3 is a partial perspective view illustrating a configuration of the printing apparatus.

FIG. 4A is a schematic view illustrating operation of the printing apparatus.

FIG. 4B is a schematic view illustrating operation of the printing apparatus.

FIG. 5 is a schematic view illustrating a configuration of a holding unit.

FIG. 6 is a plan view illustrating a configuration of a support unit.

### DESCRIPTION OF EXEMPLARY EMBODIMENTS

First, a configuration of a printing apparatus 10 will be described. The printing apparatus 10 is, for example, an ink jet-type large-format printer that performs printing (recording) on a medium M such as a sheet by discharging ink as a liquid. The large-format printer is, for example, a printer capable of performing printing on the medium M having a short side width of A3 (297 mm) or more.

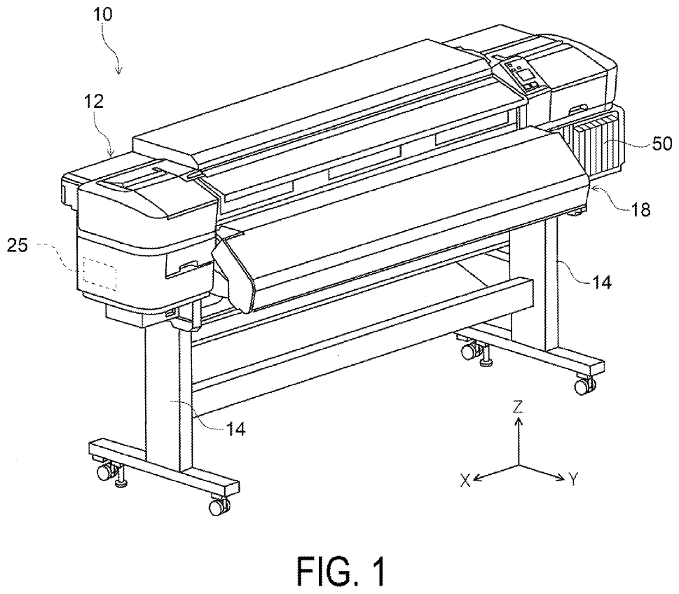

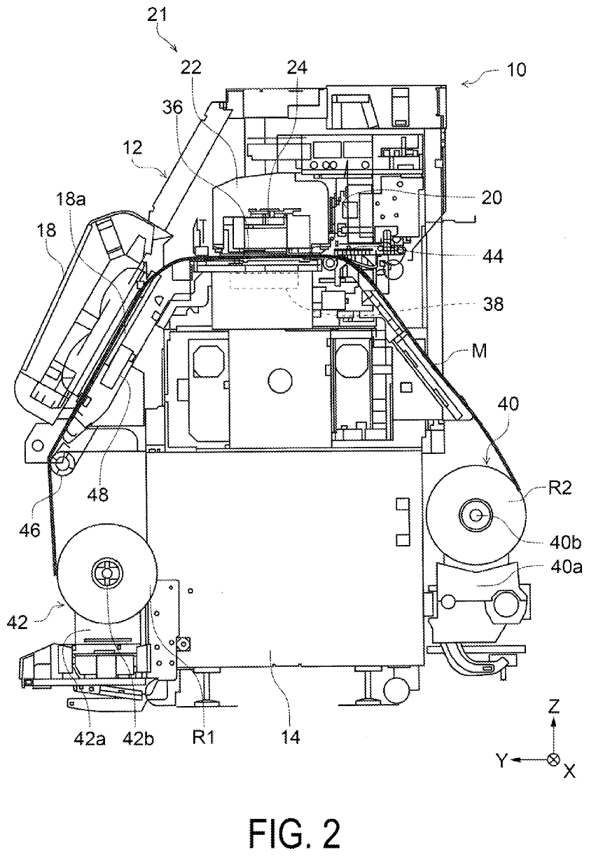

As illustrated in FIGS. 1 and 2, the printing apparatus 10 includes a main body 12 and a pair of leg portions 14. The pair of leg portions 14 are provided with some intervals in a direction along an X-axis on a lower portion of the main body 12. The leg portion 14 extends downward from the lower portion of the main body 12.

The main body 12 is formed in a rectangular parallelepiped shape, and a drying unit 18 is provided on a front surface side (+Y direction side) thereof. A main frame 20 extending in the direction along the X-axis is provided on an upper portion of the main body 12. A carriage 22 constituting a recording unit 21 is attached in the +Y direction of the main frame 20. The carriage 22 is configured to reciprocate in the direction (scanning direction) along the X-axis along the main frame 20. A head 24 constituting the recording unit 21 is mounted on a lower portion of the carriage 22. The head 24 includes a plurality of nozzles (not illustrated) capable of discharging ink downward. The head 24 is configured to discharge ink via the nozzle.

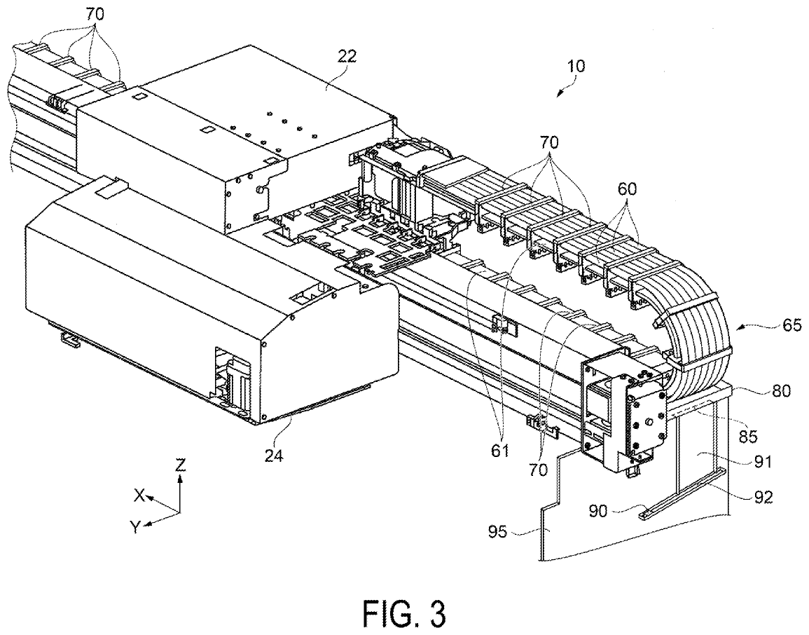

The printing apparatus 10 includes an ink tank 50 that stores ink. The ink tank 50 and the head 24 are coupled to an ink tube 60 (FIG. 3), and ink can be supplied from the ink tank 50 to the head 24 via the ink tube 60.

A suction platen 36 having a flat plate-shape extending in the direction along the X-axis is provided below the recording unit 21. The suction platen 36 includes a plurality of through holes (not illustrated) penetrating in a direction along a Z-axis.

A suction fan 38 is arranged below the suction platen 36. When the suction fan 38 is driven, gas on the upper side of the suction platen 36 is sucked through the through hole of the suction platen 36. As a result, a gas flow is formed from the upper side to the lower side of the suction platen 36. As a result, in a state in which the medium M is located on the suction platen 36, the medium M is sucked by the suction platen 36 and pressed against an upper surface of the suction platen 36.

A paper feeding unit 40 is provided on a rear side (−Y direction side) of the printing apparatus 10, and a paper discharging unit 42 is provided below the drying unit 18 on the front side (+Y direction side) of the printing apparatus 10. Note that, in FIG. 1, the paper feeding unit 40 and the paper discharging unit 42 are not illustrated. Further, in FIG. 2, the medium M is illustrated by a thick line.

The paper discharging unit 42 includes a pair of bearing units 42a and a spindle 42b. The pair of bearing units 42a are configured to move in the direction along the X-axis, which is a direction in which they come into contact with and separate from each other. The spindle 42b is inserted into an inner peripheral portion of a paper discharging roll R1. Both ends of the spindle 42b are supported by the pair of bearing units 42a. A driving force is supplied to the bearing unit 42a by a driving source (not illustrated), so that the paper discharging roll R1 supported by the spindle 42b can be wound up, that is, a front tension is applied thereto.

Similarly, the paper feeding unit 40 also includes a pair of bearing units 40a configured to move in the direction along the X-axis, and a spindle 40b. The spindle 40b is inserted into an inner peripheral portion of a paper feeding roll R2. Both ends of the spindle 40b are supported by the pair of bearing units 40a. A driving force is supplied to the bearing unit 40a by a driving source (not illustrated), so that the paper feeding roll R2 supported by the spindle 40b can be sent out downstream in a transport direction. Here, the bearing unit 40a is controlled such that a back tension is applied to the medium M drawn from the paper feeding roll R2.

In the present embodiment, the medium M is drawn from the paper feeding roll R2 of the paper feeding unit 40, passes through the suction platen 36 and the drying unit 18, and is wound by the paper discharging roll R1 of the paper discharging unit 42.

A transport roller 44 is provided upstream of the suction platen 36 in the transport direction of the medium M. The transport roller 44 is configured as a driving roller driven by a driving source (not illustrated). The transport roller 44 is configured to rotate in a forward rotation direction and a reverse rotation direction. In the present embodiment, the forward rotation direction is a direction in which the medium M wound around the paper feeding roll R2 is pulled out and the medium M is sent downstream in the transport direction, and the reverse direction is a direction in which the medium M is sent from a downstream side to an upstream side in the transport direction.

A discharging roller 46 is provided downstream of the drying unit 18. The discharging roller 46 is configured as a driving roller driven by a driving source (not illustrated).

The drying unit 18 includes a heater (not illustrated) as a heating source. The heater heats the medium M located in the drying unit 18 to evaporate moisture of the ink absorbed by the medium M to facilitate drying. A suction fan 48 is provided in the drying unit 18. The suction fan 48 extends along a transport path of the medium M in the drying unit 18, and is attached to a lower surface side of a path forming member 18a that constitutes a part of the transport path.

In the present embodiment, a plurality of through holes (not illustrated) are formed in the path forming member 18a, and when the suction fan 48 is driven, gas on an upper side of the path forming member 18a is sucked through the through holes. As a result, a gas flow is formed from the upper side to a lower side of the path forming member 18a. As a result, in a state where the medium M is located on the path forming member 18a of the drying unit 18, the medium M is sucked by the path forming member 18a and pressed against an upper surface of the path forming member 18a.

Then, the printing apparatus 10 includes a control unit 25 controlling various operations performed by the printing apparatus 10. The control unit 25 includes a CPU, a memory, a control circuit and an interface (I/F). The CPU is an arithmetic processing device. The memory is a storage device ensuring a region for storing programs of the CPU, a working region and the like and includes a storage element such as a RAM or EEPROM. For example, when recording data and the like is acquired from outside an information processing terminal or the like via the I/F, the CPU controls various drive units and the like.

As illustrated in FIG. 3, a joint unit that is coupled to the ink tube 60 is provided on a rear end portion of the carriage 22, and one end of the ink tube 60 is coupled to the joint unit. The ink tube 60 coupled to the carriage 22 extends in the −X direction from the rear end portion of the carriage 22, and is inverted while curving in the −Z direction to form a curved portion 65. Further, the ink tube 60 extends in the +X direction from the curved portion 65. The curved portion 65 is a portion of the ink tube 60 that curves convexly toward one direction (−X direction) in the scanning direction.

Note that in this embodiment, an FFC (flexible flat cable) 61 for transmitting a drive signal from the control unit 25 to the head 24 is provided. Then, one end of the FFC 61 is coupled to the carriage 22, and the FFC 61 moves together with the ink tube 60 as the carriage 22 moves. The curved portion 65 is formed by the ink tube 60 and the FFC 61.

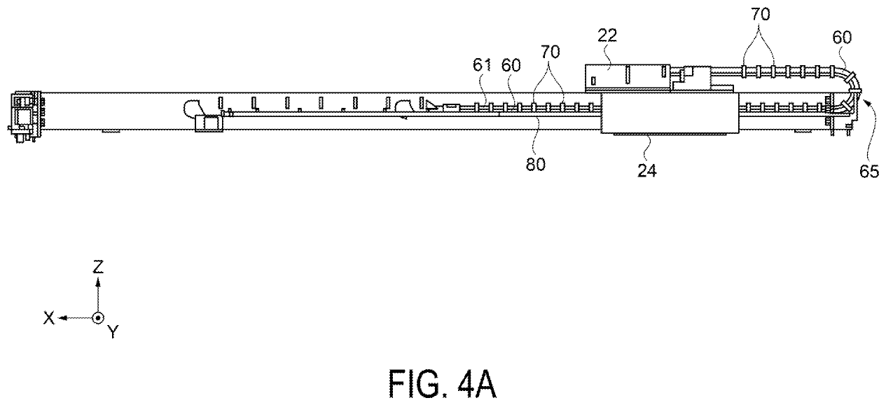

The ink tube 60 and the FFC 61 are flexible, and as illustrated in FIGS. 4A and 4B, when the carriage 22 moves in the direction along the X-axis, the ink tube 60 and the FFC 61 also follow the movement of the carriage 22 to deform. In other words, in association with the movement of the carriage 22, the curved portion 65 also moves in the movement direction of the carriage 22.

Here, as described above, according to the reciprocating movement of the carriage 22, the ink tube 60 also moves while curving. Therefore, for example, ink may leak from the joint unit of the carriage 22 coupled to the ink tube 60. Therefore, it is required to install a detection sensor 90 that detects ink leakage. However, there is a problem that the configuration becomes complicated when the detection sensor 90 is installed everywhere on the printing apparatus 10.

Therefore, in the printing apparatus 10 according to the present embodiment, the number of detection sensors 90 installed is reduced, and a configuration capable of efficiently detecting ink leakage is formed.

Hereinafter, a specific configuration will be described.

As illustrated in FIG. 3, the printing apparatus 10 includes a holding unit 70 that holds the ink tube 60. The holding unit 70 of the present embodiment holds the ink tube 60 and the FFC 61. A plurality of the holding units 70 are arranged at intervals in an extending direction of the ink tube 60. Each holding unit 70 is attached to a band-shaped coupling member (not illustrated) extending in the extending direction of the ink tube 60. As a result, the plurality of holding units 70 can move together with the carriage 22 while keeping a certain interval therebetween. That is, the holding unit 70 is a long member that holds the ink tube 60. The holding unit 70 moves in the scanning direction in a state where the ink tube 60 curves convexly toward one direction of the scanning direction. In this embodiment, as illustrated in FIGS. 4A and 4B, the ink tube 60 moves in a state of curving convexly toward the −X direction.

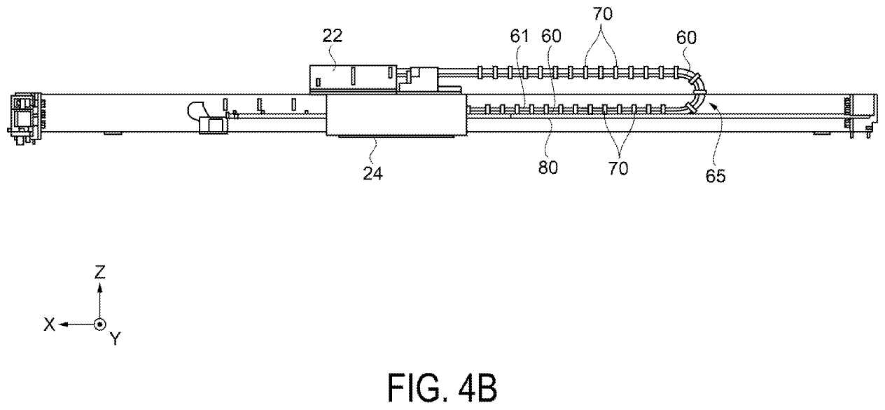

As illustrated in FIG. 5, each holding unit 70 includes a first clamping unit 71 and a second clamping unit 72. The first clamping unit 71 has a recessed portion, and the plurality of ink tubes 60 are arranged side by side in the recessed portion in a direction along the Y-axis, and by arranging the second clamping unit 72 from above with respect to the recessed portion of the first clamping unit 71, the first clamping unit 71 and the second clamping unit 72 are engaged, and the ink tube 60 is sandwiched between the first clamping unit 71 and the second clamping unit 72. In this way, the plurality of long ink tubes 60 can be bundled by the plurality of holding units 70.

Further, the second clamping unit 72 has a recessed portion on the opposite side of the ink tube 60, and the FFC 61 is arranged in the recessed portion.

The holding unit 70 is supported by a support unit 80. The support unit 80 includes a support face 81 that supports, from below, the holding unit 70 holding the ink tube 60 and the FFC 61. The holding unit 70 includes a flat portion 75 that comes into contact with and separates from the support face 81 of the support unit 80 according to the reciprocating movement of the carriage 22. The flat portion 75 has a flat surface configured to come into contact with the support face 81.

FIG. 5 illustrates a state in which the flat portion 75 of the holding unit 70 is in contact with the support face 81 of the support unit 80.

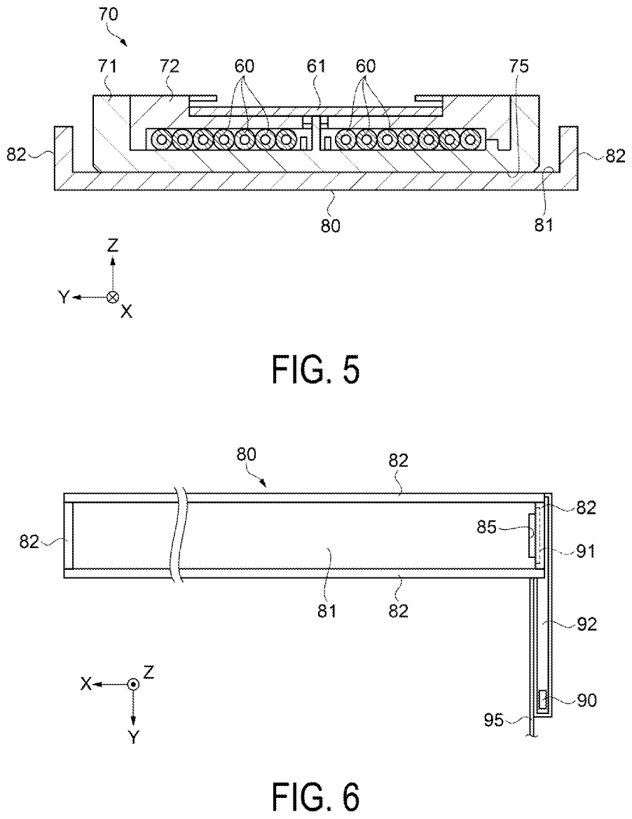

As illustrated in FIG. 6, the support unit 80 extends in the scanning direction (direction along the X-axis). In plan view, the support face 81 of the support unit 80 is defined by a wall portion 82. That is, the support unit 80 is formed in a tub shape having the support face 81 as a bottom surface.

By arranging a sealing member such as a sponge material or the like in a gap formed between the adjacent wall portions 82 and a through hole portion formed in the support face 81 for routing the ink tube 60 and the FFC 61, the gap or the like is sealed.

A discharge port 85 configured to discharge ink is arranged at one end (end in the −X direction) of the support unit 80. That is, the discharge port 85 is arranged, in the support unit 80, in the same direction as the direction in which the ink tube 60 is convexly curved in the direction along the X-axis. The discharge port 85 is provided in a region defined by the wall portion 82 or the like of the support face 81. The discharge port 85 is a through hole provided in the support face 81.

The printing apparatus 10 includes the detection sensor 90 configured to detect presence or absence of ink. The detection sensor 90 is arranged on one end side of the support unit 80 in the direction in which the ink tube 60 is curved in the convex shape. That is, the detection sensor 90 is provided on an end side of the support unit 80 in the −X direction.

As illustrated in FIGS. 3 and 6, the detection sensor 90 according to the present embodiment is arranged below the discharge port 85. More specifically, the discharge port 85 is provided with a first guide 91 arranged along the −Z direction from the discharge port 85, and a second guide 92 having one end side that inclines downward is coupled to the first guide 91. The first guide 91 and the second guide 92 are arranged at a side frame 95 provided in the main body 12.

Then, the detection sensor 90 is arranged on one end side of the second guide 92, that is, on the side of the second guide 92 having a lower height in the +Z direction.

The detection sensor 90 is coupled to the control unit 25. The detection sensor 90 is constituted by a pair of electrode terminals (not illustrated). Electric resistance between the electrode terminals changes according to the amount of ink adhering between the electrode terminals, and the control unit 25 determines whether or not ink has adhered to the detection sensor 90 based on the change in the electric resistance. That is, presence or absence of ink leakage can be detected.

Next, action and effect of the printing apparatus 10 will be described.

For example, when ink leaks from the joint unit of the carriage 22 to which the ink tube 60 is coupled, the leaked ink leaks to the support face 81 of the support unit 80 via the ink tube 60. Then, the ink transmitted to the support face 81 is pushed out in the direction in which the ink tube 60 is curved in the convex shape, by the movement of the plurality of holding units 70 associated with the reciprocating movement of the carriage 22 in the scanning direction. At this time, since the flat portion 75 of the holding unit 70 repeatedly contacts and separates from the support face 81, the ink on the support face 81 can be efficiently pushed out to one end side (−X direction).

The ink pushed out in the −X direction is discharged from the discharge port 85 provided at the end of the support face 81 in the −X direction. Since the support face 81 is defined by the wall portion 82 or the like, ink leakage from other than the discharge port 85 is suppressed, and the ink can be efficiently guided to the discharge port 85.

The ink discharged from the discharge port 85 flows through the first guide 91 to the second guide 92. The ink that has reached the second guide 92 reaches the detection sensor 90 along a slope. The control unit 25 determines the presence of ink (ink leakage) according to a detection signal from the detection sensor 90.

In the printing apparatus 10 according to the present embodiment, ink leakage can be detected only by arranging the detection sensor 90 at one location without arranging the detection sensors 90 at a plurality of locations. Therefore, a configuration of the printing apparatus 10 can be simplified.

In other words, by configuring the leaked ink to flow positively toward the detection sensor 90, efficiency of ink leak detection can be improved.

Note that in the embodiments described above, the support face 81 of the support unit 80 is arranged on a horizontal plane. However, the disclosure is not limited to this. For example, the support face 81 of the support unit 80 may be inclined downward from the other end (+X direction) to one end (−X direction) in the scanning direction. For example, the support face 81 is inclined by approximately 5° to 10° with respect to the horizontal plane. In this way, ink can easily flow to the discharge port 85 side, and ink leakage can be detected more quickly.

What is claimed is:

1. A printing apparatus comprising:
a head configured to discharge ink,
a carriage mounted with the head and configured to reciprocate in a scanning direction,
an ink tank configured to store the ink,
an ink tube coupling the head and the ink tank,
a holding unit configured to hold the ink tube and move in the scanning direction with the carriage,
a support unit extending in the scanning direction and including a support face that supports the holding unit from below, and
a detection sensor configured to detect presence or absence of the ink, wherein
the holding unit moves in the scanning direction with the ink tube curving in a convex shape toward one direction in the scanning direction,
the holding unit includes a flat portion that comes into contact with and separates from the support face of the support unit according to the reciprocating movement of the carriage, and
the detection sensor is arranged on one end side of the support unit in a direction in which the ink tube curves in the convex shape.

2. The printing apparatus according to claim 1, wherein
a discharge port configured to discharge the ink is provided at the one end of the support unit, and
the detection sensor is located below the discharge port.

3. The printing apparatus according to claim 2, wherein
in plan view from above, a periphery of the support face of the support unit is defined by a wall portion, and the discharge port is provided in the defined region.

4. The printing apparatus according to claim 1, wherein
the support unit is inclined downward from the other end toward the one end.
